(19) United States
(12) Patent Application Publication
(10) Pub. No.: US 2009/0216843 A1
(43) Pub. Date: Aug. 27, 2009

(54) SYSTEM AND METHOD FOR COLLABORATIVE EMAIL REVIEW

(76) Inventors: BARRY E. WILLNER, Briarcliff Manor, NY (US); Robert Cameron Weir, Westford, MA (US); Edith Helen Stern, Yorktown Heights, NY (US); Patrick Joseph O'Sullivan, Ballsbridge (IE)

Correspondence Address: HOLLAND & KNIGHT, 10 ST. JAMES AVENUE, BOSTON, MA, 02116-3889, US

(21) Appl. No.: 12/037,524

(22) Filed: Feb. 26, 2008

(51) Int. Cl. G06F 15/16

(52) U.S. Cl. 709/206

(57) ABSTRACT

A method and computer program product for enabling a user to compose a draft email. The user is enabled to send the draft email as a draft email for review to one or more specified reviewing recipients. A copy of the draft email is saved. The saved copy of the draft email is configured to be sent to one or more additional recipients as an original email.

### TECHNICAL FIELD

This disclosure relates to communications email systems, and more particularly to email systems allowing for collaborative review of email.

### BACKGROUND

In the present internet and electronic communication age, email is an increasingly prevalent means of communication, especially mass communication, because it allows the same message to be easily sent to a large group of people. However, unlike conventional written correspondence, email communications present challenges for having an email message reviewed by others prior to sending to an ultimately intended recipient as an original email message rather than a forwarded email message. For example, the user must type and send the email message to the reviewer. When the user receives a reply from the reviewer, the user must then compare the reply to the original for any differences due to edits and then copy and paste the reply email message, or some version of it, into a new email message for sending to the intended recipient. Thus, there exists a need for a collaborative email review system that will enable the user to send a draft message for review and save it for comparison and sending to the intended recipient.

### SUMMARY OF THE DISCLOSURE

In a first implementation, a method includes enabling a user to compose a draft email. The user may be enabled to send the draft email as a draft email for review to one or more specified reviewing recipients. A copy of the draft email may be saved. The saved draft email is configured to be sent to one or more additional recipients as an original email.

One or more of the following features may be included. The one or more specified reviewing recipients may be prevented from forwarding the draft email for review to a recipient other than the user. The saved copy of the draft email may be saved without a specified recipient. The user may be enabled to send the saved copy of the draft email to one or more specified recipients as an original email.

A response email may be received from the one or more specified reviewing recipients, the response including a reviewed draft email. At least a portion of the reviewed draft email may be compared to at least a portion of the saved copy of the draft email. A verification of equivalence between at least a portion of the saved copy of the draft email and at least a portion of the reviewed draft email may be provided. An indication of one or more differences between at least a portion of the reviewed draft email and the saved copy of the draft email may be provided. The user may be enabled to merge at least a portion of the reviewed draft email and the saved copy of the draft email.

The saved copy of the draft email may include one or more attachments. The one or more attachments in the saved copy of the draft email may be compared to one or more reviewed attachments received in a response email.

According to another implementation, a computer program product resides on a computer readable medium, having a plurality of instructions stored on it. When executed by a processor, the instructions cause the processor to perform operations including enabling a user to compose a draft email. The instructions further cause the processor to enable the user to send the draft email as a draft email for review to one or more specified reviewing recipients. The instructions further cause the processor to save a copy of the draft email. The saved copy of the draft email is configured to be sent to one or more additional recipients as an original email.

One or more of the following features may be included. The instructions may further cause the processor to prevent the one or more specified reviewing recipients from forwarding the draft email for review to a recipient other than the user. The saved copy of the draft email may be saved without a specified recipient. The instructions may further cause the processor to enable the user to send the saved copy of the draft email to one or more specified recipients as an original email.

A response email may be received from the one or more specified reviewing recipients, the response including a reviewed draft email. The instructions may further cause the processor to compare at least a portion of the reviewed draft email to at least a portion of the saved copy of the draft email. The instructions further cause the processor to provide a verification of equivalence between at least a portion of the saved copy of the draft email and at least a portion of the reviewed draft email. The instructions may further cause the processor to provide an indication of one or more differences between at least a portion of the reviewed draft email and the saved copy of the draft email. The instructions may further cause the processor to enable the user to merge at least a portion of the reviewed draft email and the saved copy of the draft email.

The saved copy of the draft email may include one or more attachments. The instructions may further cause the processor to compare the one or more attachments in the saved copy of the draft email to one or more reviewed attachments received in a response email.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a collaborative email review process and an email application coupled to a distributed computing network.

FIG. 2 is a flowchart of a process executed by the collaborative email review process of FIG. 1.

FIG. 3 is a diagrammatic view of draft email provided by the collaborative email review process and/or the email application of FIG. 1.

FIG. 4 is a diagrammatic view of an email for review provided by the collaborative email review process and/or the email application of FIG. 1.

FIG. 5 is a diagrammatic view of a reviewed email received by the collaborative email review process and/or the email application of FIG. 1.

FIG. 6 is a diagrammatic view of a display screen rendered by the collaborative email review process and/or the email application of FIG. 1.

### DETAILED DESCRIPTION

### System Overview

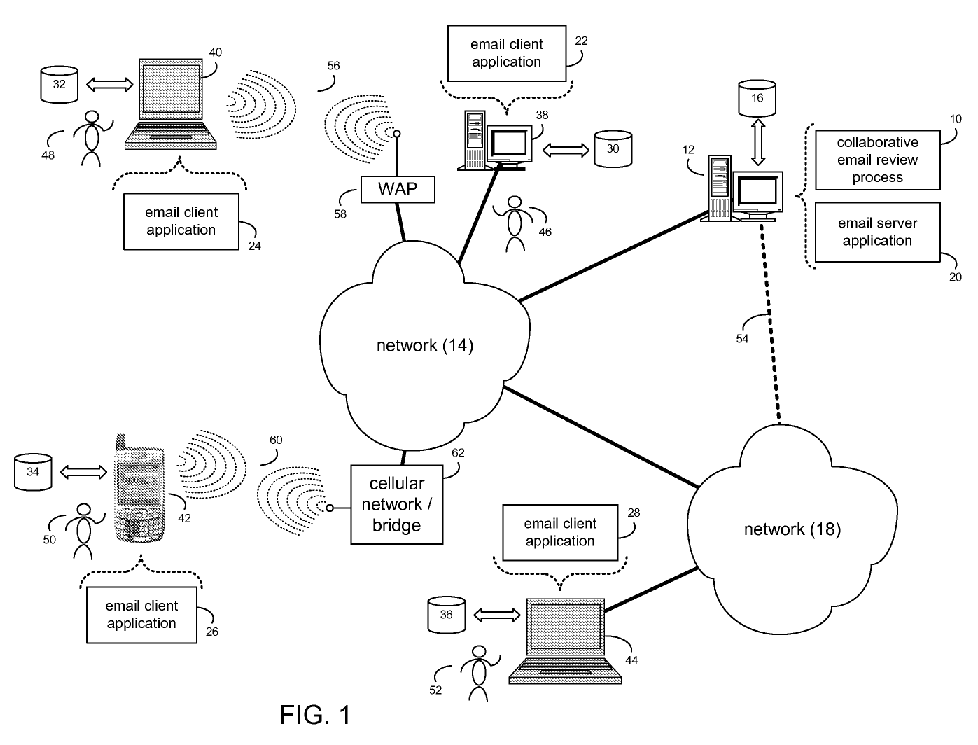

Referring to FIG. 1, there is shown collaborative email review process 10 that may reside on and may be executed by server computer 12, which may be connected to network 14 (e.g., the internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, the collaborative email review process may reside on a client electronic device, such as a personal computer, notebook computer, personal digital assistant, or the like.

As will be discussed below in greater detail, collaborative email review process 10 may enable a user to compose a draft email. The user may be enabled to send the draft email as a draft email for review to one or more specified reviewing recipients. A copy of the draft email may be saved. The saved draft email may be configured to be sent to one or more additional recipients as an original email.

The instruction sets and subroutines of collaborative email review process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more email server applications (e.g., email server application 20), examples of which may include but are not limited to, e.g., Lotus Domino ™ Server and Microsoft Exchange™ Server. Email server application 20 may interact with one or more email client applications (e.g., email client applications 22, 24, 26, 28) for routing and managing email communications. Examples of email client applications 22, 24, 26, 28 may include, but are not limited to, e.g., Lotus Notes™ and Microsoft Outlook™, Collaborative email review process 10 may be a stand-alone application that interfaces with email server application 20 or may be an applet/application that is executed within email server application 20.

The instruction sets and subroutines of email server application 20, which may be stored on storage device 16 coupled to server computer 12, may be executed by one or more processors (not shown) and one or more memory architectures (not shown) incorporated into server computer 12.

As mentioned above, in addition/as an alternative to being a server-based application residing on server computer 12, the collaborative email review process may be a client-side application (not shown) residing on one or more client electronic devices 38, 40, 42, 44 (e.g., stored on storage devices 30, 32, 34, 36, respectively). As such, the collaborative email review process may be a stand-alone application that interfaces with an email client application (e.g., email client applications 22, 24, 26, 28), or may be an applet/application that is executed within an email client application. As such, the collaborative email review process may be a client-side process, a server-side process, or a hybrid client-side/server-side process, which may be executed, in whole or in part, by server computer 12, or one or more of client electronic devices 38, 40, 42, 44.

The instruction sets and subroutines of email client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using email client applications 22, 24, 26, 28, users 46, 48, 50, 52 may send, receive, manage, etc., email communications. Sending, receiving, and managing email communications may include accessing and/or interacting with email server application 20.

Users 46, 48, 50, 52 may access email server application 20 directly through the device on which the email client application (e.g., email client applications 22, 24, 26, 28) is executed, namely client electronic devices 38, 40, 42, 44, for example. Users 46, 48, 50, 52 may access email server application 20 directly through network 14 or through secondary network 18. Further, server computer 12 (i.e., the computer that executes email server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### Collaborative Email Review Process

For illustrative purposes email client application 22 will be discussed. However, this should not be construed as a limitation of the present disclosure, as other email client applications (e.g., email client applications 24, 26, 28) may be equally utilized.

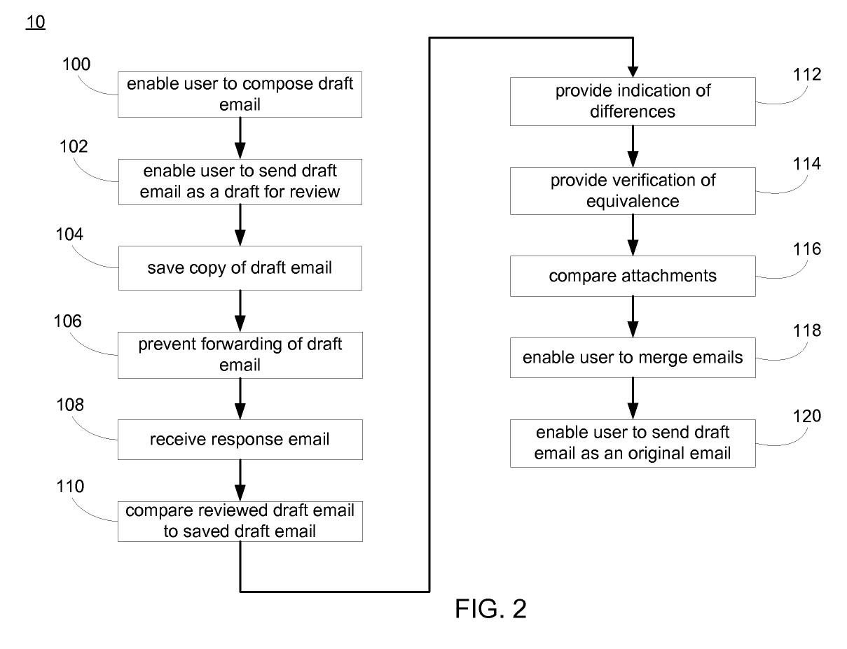

Referring also to FIG. 2, collaborative email review process 10 may enable 100 a user to compose a draft email. Collaborative email review process 10 may enable 102 the user to send the draft email as a draft email for review to one or more specified reviewing recipients. Collaborative email review process 10 may save 104 a copy of the draft email. The saved copy of the draft email may be configured to be sent to one or more additional recipients as an original email.

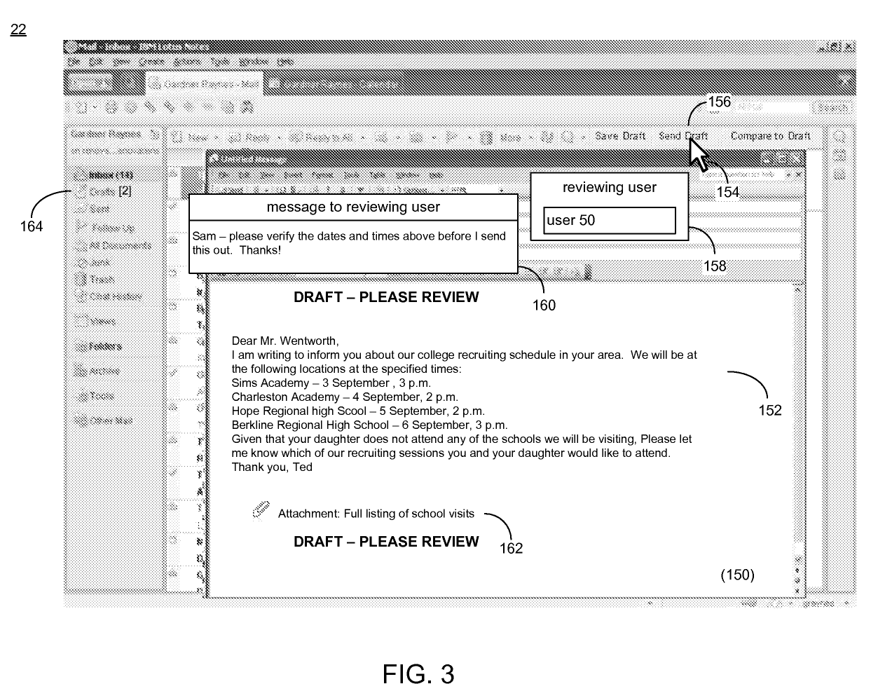

For example, and referring also to FIG. 3, collaborative email review process 10 (alone or in conjunction with email client application 22 and/or email server application 20) may enable 100 user 46 to compose a draft email 150, including message content 152 (i.e., the body of the email message) that may be ultimately intended for user 48. While draft email 150 may be ultimately intended for user 48, collaborative email review process 10 may allow user 46 to prepare draft email 150 for review by one or more users (e.g., user 50) other than user 48. For example, user 50 may review draft email 150 (e.g., to provide feedback, comments, corrections, or the like) prior to user 46 sending draft email 150 to user 48.

Continuing with the above-stated example, collaborative email review process 10 (alone or in conjunction with one or more of email client application 22 and/or email server application 20) may enable 102 user 46 to send draft email 150 as a draft email for review to one or more specified reviewing recipients (e.g., user 50). For example, user 46 may select, via onscreen pointer 154 controlled by a pointing device (e.g., a mouse; not shown) “send draft” button 156. Selecting “send draft” button 156 may result in collaborative email review process 10 (alone or in conjunction with one or more of email client application 22 and/or email server application 20) rendering reviewing user pop-up 158. Collaborative email review process 10 may allow user 46 to specify user 50 (e.g., by inputting user 50's name and/or email address using a keyboard, dropdown menu, or the like, not shown) as the reviewing recipient in reviewing pop-up 158.

Collaborative email review process 10 may allow user 46 to provide a message to the reviewing user, e.g., which may not be included as part of draft email 150. For example, collaborative email review process 10 (alone or in conjunction with one or more of email client application 22 and/or email server application 20) may render message pop-up 160, into which user 46 may input (e.g., via a keyboard; not shown) a message to user 50 (e.g., “Sam—please verify the dates and times above before I send this out. Thanks!”). Once user 46 has input a desired message to reviewing user 50 (e.g., upon pressing the “enter” key on the keyboard, or selecting a “finished button”; not shown), collaborative email review process 10 may enable 102 user 46 to send draft email 150 as a draft email for review to user 50. As shown, draft email 150 may include at least one indicator (namely, “DRAFT—PLEASE REVIEW”) that the draft email 150 is a draft email for review. Additionally, draft email 150 may include one or more attachments 162.

Once user 46 has input a desired reviewing user (i.e., user 50) in reviewing user pop-up 158 and any desired message to the reviewing user in message pop-up 160, collaborative email review process 10 (alone or in conjunction with one or more of email client application 22 and/or email server application 20) may allow user 46 to send draft email 150 to the reviewing user (i.e., user 50). For example, user 46 may again select, via onscreen pointer 154, send draft button 156. In addition to sending draft email 150 to user 50 for review, collaborative email review process 10 may save 104 a copy of draft email 150, e.g., in drafts folder 164. Collaborative email review process 10 may save 104 draft email 150 without a specified recipient. For example, though user 46 may have one or more intended recipients (e.g., user 48) to whom user 46 may ultimately intent to send draft email 150, user 46 may not specify the intended recipient when saving 104 draft email 150. Similarly, while collaborative email review process 10 may enable 102 user 46 to send draft email 150 to a reviewing recipient (e.g., user 50), collaborative email review process 10 may save 104 draft email 150 without specifying the reviewing recipient in the saved 104 copy of draft email 150 in drafts folder 164.

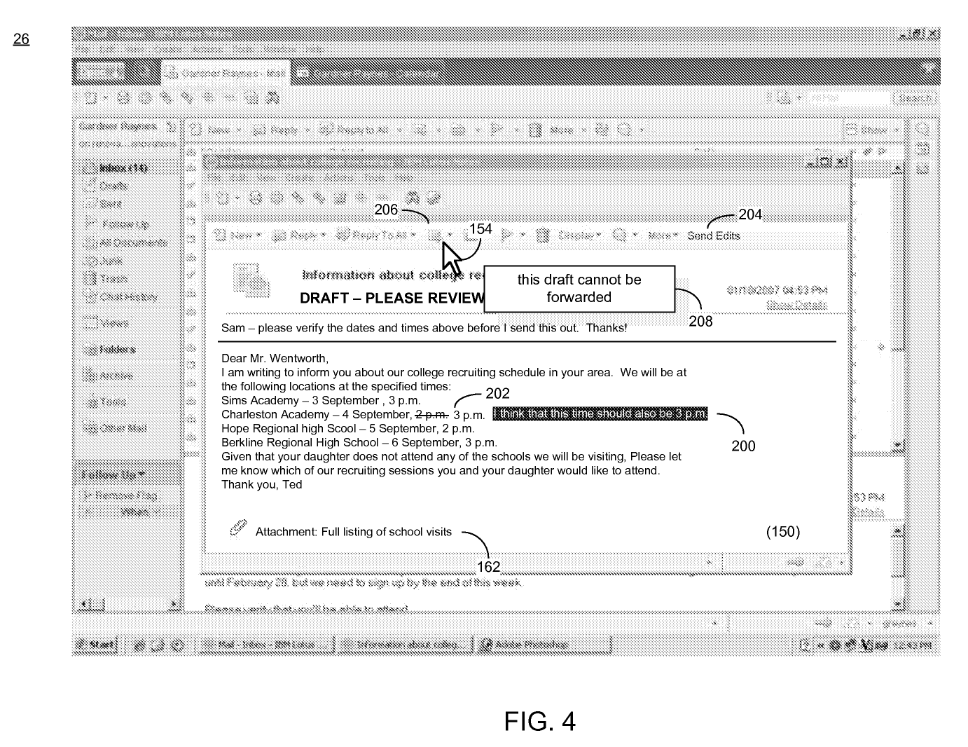

Referring also to FIG. 4, user 50 may receive draft email 150, e.g., via email client application 26. Collaborative email review process 10 may allow user 50 to review draft email 150. User 50 may review draft email 150 including, e.g., proof reading, checking the accuracy of facts, and making sure the tone of draft email 150 is appropriate, etc. User 50 may respond to user 46 indicating that draft email 150 is fine as is. Alternatively, user 50 may suggest changes to draft email 150. For example, collaborative email review process 10 (alone or in conjunction with one or more of email client application 26 and/or email server application 20) may allow user 50 to insert one or more comments 200 and/or make one or more edits 202 (e.g., using onscreen pointer 154 and/or a keyboard; not shown). Once user 50 has made any desired comments 200 and/or edits, user 50 may send the edited draft email back to user 46, e.g., by selecting, via onscreen pointer 154, “Send Edits” button 204.

Collaborative email review process 10 may prevent 106 the one or more specified reviewing recipients (e.g., user 50) from forwarding the draft email for review to a recipient other than the originator of the email (i.e., user 46). For example, collaborative email review process 10 may configure draft email 150 such that a forward option is blocked, preventing 106 draft email for review from being forwarded to any other users by the specified reviewing recipient (i.e., user 50). For example, if user 50 attempts to forward draft email 150, e.g., by selecting, via onscreen pointer 154, forward button 206, collaborative email review process 10 (alone or in conjunction with one or more of email client application 26 and/or email server application 20) may provide warning 208 (namely, “this draft cannot be forwarded). Additionally/alternatively, while not shown, user 50 may be prevented from copying the text of draft email 150 (e.g., resulting in a warning similar to warning 208).

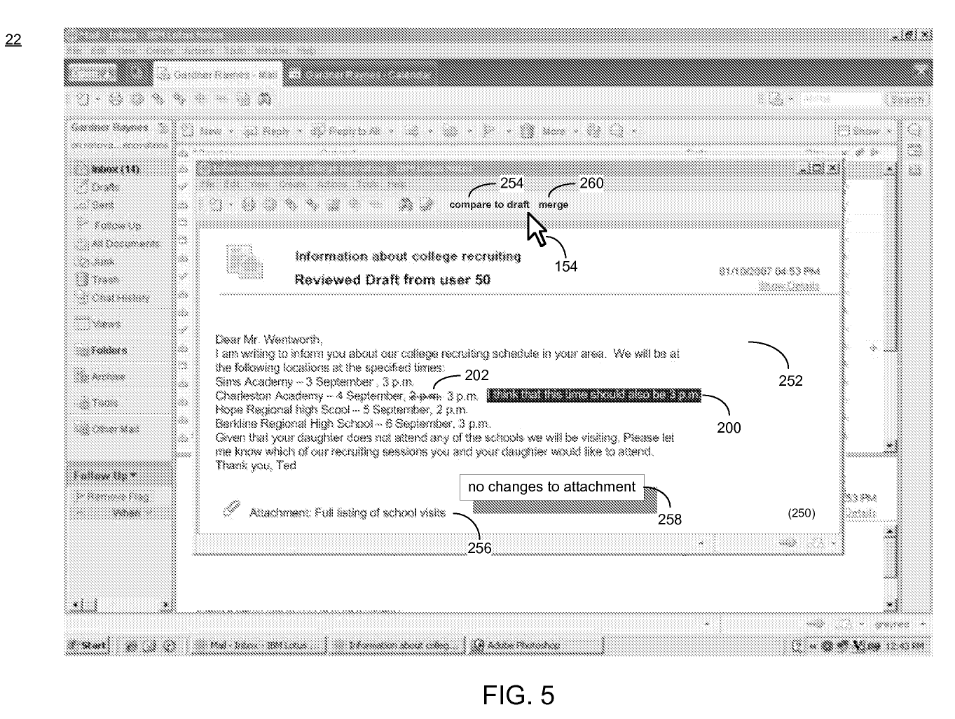

Referring also to FIG. 5, collaborative email review process 10 (alone or in conjunction with one or more of email client application 22 and/or email server application 20) may receive 108 response email 250 from the one or more specified reviewing recipients (i.e., from user 50). As discussed above, during review of draft email 150, user 50 may revise or edit draft email 150 and/or may provide one or more comments relative to draft email 150. Collaborative email review process 10 may compare 110 at least a portion of reviewed draft email 250 (e.g., email message body 252) to at least a portion of the saved 104 draft email 150 (e.g., email message body 152). For example, user 46 may select compare to draft option 254, resulting in collaborative email review process 10 providing 112 an indication of one or more differences between reviewed draft email 250 and draft email 150, namely comments 200 and/or edits 202 which may have been created by user 50 during review of draft email 150.

In the event that the reviewed draft email does not include any comments and/or edits, upon selecting compare to draft option 254, collaborative email review process 10 may provide 114 a verification of equivalence between saved 104 draft email 150 and reviewed draft email 250. While not shown, the verification of equivalence between saved 104 draft email 150 and reviewed draft email 250 may include, for example, a pop-up dialog boxing indicating that no differences exist, or other similar indication of equivalence.

As mentioned above, draft email 150 may include attachment 162. Comparing 110 reviewed draft email 250 and saved 104 draft email 150 may include comparing 116 attachment 256 of reviewed draft email 250 with attachment 162 of saved 104 draft email 150. Collaborative email review process 10 (alone or in conjunction with one or more of email client application 22 and/or email server application 20) may, for example, render pop-up 258 indicating if any changes have been made to attachment 256 of reviewed draft email 250 relative to attachment 162 of saved 104 draft email 150. While pop-up 258 is shown indicating “no changes to attachment”, in the event of any differences between attachment 256 (e.g., as a result of edits and/or comments by the reviewing user) and attachment 162, collaborative email review process 10 may provide an indicator of any differences, e.g., either in pop-up 258 and/or via highlighting, annotation, etc., within attachment 256.

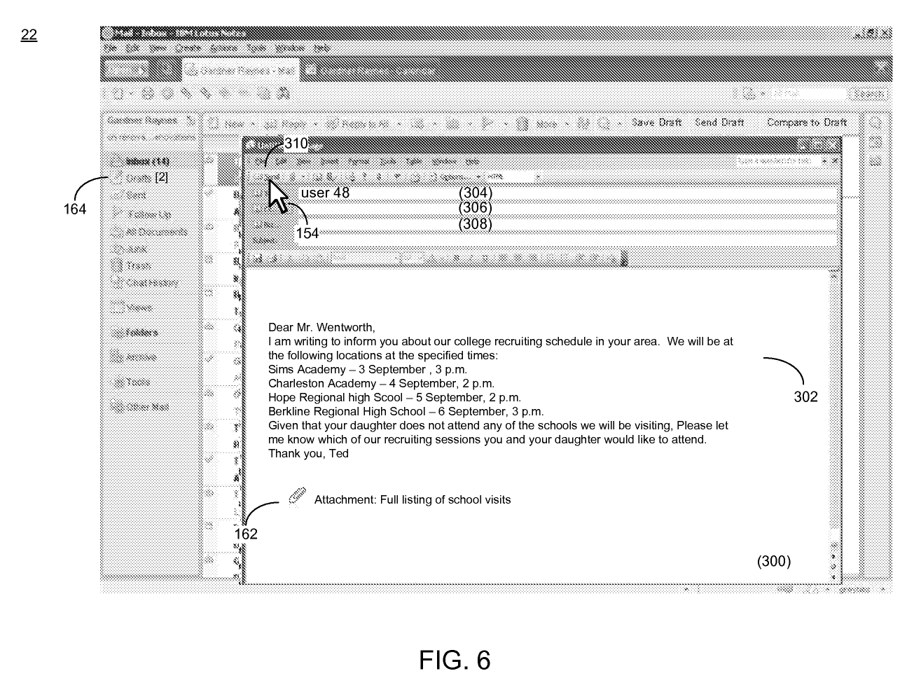

Collaborative email review process 10 may enable the user to merge 118 at least a portion of the reviewed draft email 250 and the saved 104 draft email 150, e.g., thereby accepting edits 202 made by user 50. For example, user 46 may select, via onscreen pointer 154, merge option 260. Referring also to FIG. 6, selecting merge option 260 may result in collaborative email review process 10 (alone or conjunction with one or more of email client application 22 and/or email server application 20) rendering new email 300 include email content 302 (i.e., the body of the email message). Content 302 may include the merged content 152 of saved 104 draft email 150 and content 252 of reviewed draft email 250 received from user 50. Collaborative email review process 10 (alone or in conjunction with one or more of email client application 22 and/or email server application) may allow user 46 to further edit new email 300, e.g., to make further edits and/or modifications.

Continuing with the above-stated example, collaborative email review process 10 (alone or in conjunction with one or more of email client application 22 and/or email server application 20) may allow user 46 to address email 300 to one or more “TO” recipients 304 (e.g., to user 48), “CC” (i.e., carbon copy) recipients 306, and/or “BCC” (i.e., blind carbon copy) recipients 308. Collaborative email review process 10 (alone or in conjunction with one or more of email client application 22 and/or email server application 20) may allow user 46 to send 120 email 300 (i.e., send draft email 150 incorporating edits 202 from user 50) to user 48 (i.e., the “TO” recipient 304) as an original email, e.g., by selecting, via onscreen pointer 154, send button 310. That is, collaborative email review process 10 may allow user 46 to send email 300 to user 48 as an original email, without any indication that the email may have been previously sent to one or more additional users (e.g., as may be the case with forwarded email messages, reply email messages, and the like).

In a similar manner to the foregoing, a reviewing user (e.g., user 50) may not make any edits and/or provide comments. Similarly, user 46 may not wish to incorporate edits provided by user 50. Further, collaborative email review process 10 may not receive 108 a response email from user 50. In the above situations, collaborative email review process 10 may enable user 46 to send 120 saved 104 draft email 150 to one or more additional recipients (e.g., in addition to reviewing recipient user 50) as an original email (e.g., without indicators of saved 104 draft email 150 having been previously sent to one or more reviewing users). For example, user 46 may open saved 104 draft email 150 from within drafts folder 164. User 46 may address saved 104 draft email 150 to one or more “TO” recipients, “CC” recipients, and/or “BCC” recipients, in the manner generally discussed above. Additionally, user 46 may edit saved 104 draft email 150 in a conventional manner. Collaborative email review process 10 (alone or in conjunction with one or more of email client application 22 and/or email server application) may send 120 saved 104 draft email 150 to the one or more recipients as an original email.

A number of implementations have been described. Nevertheless, it will be understood that various modifications may be made. Accordingly, other implementations are within the scope of the following claims.

What is claimed is:

1. A method comprising:
enabling a user to compose a draft email;
enabling the user to send the draft email as a draft email for review to one or more specified reviewing recipients; and
saving a copy of the draft email configured to be sent to one or more additional recipients as an original email.

2. The method of claim 1, further including preventing the one or more specified reviewing recipients from forwarding the draft email for review to a recipient other than the user.

3. The method of claim 1, wherein the saved copy of the draft email is saved without a specified recipient.

4. The method of claim 1, further including enabling the user to send the saved copy of the draft email to one or more specified recipients as an original email.

5. The method of claim 1, further including:
receiving a response email from the one or more specified reviewing recipients, the response including a reviewed draft email; and
comparing at least a portion of the reviewed draft email to at least a portion of the saved copy of the draft email.

6. The method of claim 5, further including providing a verification of equivalence between at least a portion of the saved copy of the draft email and at least a portion of the reviewed draft email.

7. The method of claim 5, further including providing an indication of one or more differences between at least a portion of the reviewed draft email and the saved copy of the draft email.

8. The method of claim 7, further including enabling the user to merge at least a portion of the reviewed draft email and the saved copy of the draft email.

9. The method of claim 1, wherein the saved copy of the draft email includes one or more attachments.

10. The method of claim 9, further including comparing the one or more attachments in the saved copy of the draft email to one or more reviewed attachments received in a response email.

11. A computer program product residing on a computer readable medium having a plurality of instructions stored thereon which, when executed by a processor, cause the processor to perform operations comprising:
enabling a user to compose a draft email;
enabling the user to send the draft email as a draft email for review to one or more specified reviewing recipients; and
saving a copy of the draft email configured to be sent to one or more additional recipients as an original email.

12. The computer program product of claim 11, further including preventing the one or more specified reviewing recipients from forwarding the draft email for review to a recipient other than the user.

13. The computer program product of claim 11, wherein the saved copy of the draft email is saved without a specified recipient.

14. The computer program product of claim 11, further including enabling the user to send the saved copy of the draft email to one or more specified recipients as an original email.

15. The computer program product of claim 11, further including:
receiving a response email from the one or more specified reviewing recipients, the response including a reviewed draft email; and
comparing at least a portion of the reviewed draft email to at least a portion of the saved copy of the draft email.

16. The computer program product of claim 15, further including providing a verification of equivalence between at least a portion of the saved copy of the draft email and at least a portion of the reviewed draft email.

17. The computer program product of claim 15, further including providing an indication of one or more differences between at least a portion of the reviewed draft email and the saved copy of the draft email.

18. The computer program product of claim 17, further including enabling the user to merge at least a portion of the reviewed draft email and the saved copy of the draft email.

19. The computer program product of claim 11, wherein the saved copy of the draft email includes one or more attachments.

20. The computer program product of claim 19, further including enabling the user to compare the one or more attachments in the saved copy of the draft email to one or more reviewed attachments received in a response email.
